(19) United States
(12) Patent Application Publication
(10) Pub. No.: US 2018/0170733 A1
(43) Pub. Date: Jun. 21, 2018

(54) INDUSTRIAL TRUCK HAVING A CONTROL UNIT FOR REGULATING THE MOVEMENT OF A HYDRAULIC CYLINDER, AND METHOD FOR CONTROLLING THE SAME

(71) Applicant: Jungheinrich Aktiengesellschaft, Hamburg (DE)

(72) Inventors: Julia Leichnitz, Hamburg (DE); Stephan Scharf, Hamburg (DE); Frank Mänken, Henstedt-Ulzburg (DE)

(73) Assignee: Jungheinrich Aktiengesellschaft, Hamburg (DE)

(21) Appl. No.: 15/843,433

(22) Filed: Dec. 15, 2017

(30) Foreign Application Priority Data
Dec. 15, 2016 (DE) 102016124505.4

(51) Int. Cl. B66F 9/22; B66F 9/07; B66F 9/08; B66F 9/12; B66F 9/20; F15B 11/04; F15B 15/22

(52) U.S. Cl. CPC B66F 9/22; B66F 9/07; B66F 9/082; F15B 15/22; B66F 9/205; F15B 11/04; B66F 9/122

(57) ABSTRACT

An industrial truck comprises a lift frame having a load part for carrying a load and a hydraulic system including at least one hydraulic cylinder having a piston rod disposed within a cylindrical housing, and a hydraulic power unit. At least one sensor is configured to determine at least one of: (i) an actual speed of the piston rod of the at least one hydraulic cylinder, and (ii) an actual acceleration of the piston rod of the at least one hydraulic cylinder. Furthermore, a control unit is configured to: (i) receive at least one of a target speed of the piston rod and a target acceleration of the piston rod, (ii) determine at least one of a speed control deviation value from the target speed, and an acceleration control deviation value from the target acceleration, and, (iii) regulate at least one of the actual speed of the piston rod based on the actual speed control deviation value and the actual acceleration of the piston rod based on the actual acceleration control deviation value.

### CROSS REFERENCE TO RELATED INVENTION

This application is based upon and claims priority to, under relevant sections of 35 U.S.C. § 119, German Patent Application No. 10 2016 124 505.4, filed Dec. 15, 2016, the entire contents of which are hereby incorporated by reference.

### TECHNICAL FIELD

The disclosure relates to a control unit for regulating the movement, or rate-of-change, of a hydraulic cylinder of an industrial truck and a method for operating the same.

### BACKGROUND

Known industrial trucks normally have a vehicle frame, a lift frame, as well as a drive for moving the lift frame relative to the vehicle frame. By means of the drive, a lifting device of the industrial truck can for example be controlled, and accordingly a load located on a load part of the lift frame can be lifted. The load part, or the entire lift frame, can also be thrusted horizontally relative to the vehicle frame by means of a thrusting device. Additionally, tilting devices are known for tilting the load part, or the entire lift frame, relative to the vehicle frame. The lifting, thrusting and tilting of the lift frame, or the load part, is normally achieved by retracting, or extending hydraulic cylinders.

The desired movement, or rate-of-change, of a load located is carried out by controlling the corresponding hydraulic cylinders. The extension or retraction speed of the hydraulic cylinders, and the movement, rate-of-change, speed of the load, is normally regulated by controlling the volumetric flow within the hydraulic system of the industrial truck. This is accomplished, for example, by changing the actual speed of the hydraulic pump, or changing the valve openings of the valves of the hydraulic system. For example, a desired lifting speed of the load part can be achieved by increasing the rotary speed of the pump, or varying valve openings to the valves leading to the lift cylinders. Frequently, speed regulation of the hydraulic systems are not sufficiently precise. More specifically, external influences can cause deviations in the actual speed vs. desired speed of the load. Such disturbances in the hydraulic systems can, for example, occur as a result of dragging loads, changing oil viscosities, variable temperatures, or irregular flows in distribution due to different loads on the hydraulic cylinder.

### BRIEF SUMMARY OF THE INVENTION

An industrial truck is provided comprising, inter alia, a lift frame having a load part for carrying a load and a hydraulic system including at least one hydraulic cylinder having a piston rod disposed within a cylindrical housing, and a hydraulic power unit. the piston rod of the hydraulic cylinder connects to and acts on the lift frame. At least one sensor is configured to determine at least one of: (i) an actual speed of the piston rod of the at least one hydraulic cylinder, and (ii) an actual acceleration of the piston rod of the at least one hydraulic cylinder. A control unit is configured to: (i) receive at least one of a target speed of the piston rod and a target acceleration of the piston rod, (ii) determine at least one of a speed control deviation value from the target speed, and an acceleration control deviation value from the target acceleration, and, (iii) regulate at least one of the actual speed of the piston rod based on the actual speed control deviation value and the actual acceleration of the piston rod based on the actual acceleration control deviation value.

A method is also provided for regulating the movement of a piston rod of a hydraulic cylinder acting on a lift frame of an industrial truck. The method includes the steps of: determining a target speed and/or a target acceleration in connection with the piston rod of the at least one hydraulic cylinder, which target speed and/or acceleration values are received within a processor or control unit of the industrial truck. At least one sensor unit of the industrial truck determines the actual speed and/or the actual acceleration of the piston rod during operation. The control unit then determines a control deviation or a difference value between the actual speed and a target speed, and/or the actual acceleration and a target acceleration. From the difference or control deviation values, the actual speed or acceleration of the piston rod may be determined.

According to one embodiment of the disclosure, a target speed, a target acceleration or a target speed/target acceleration for the piston rod of the at least one hydraulic cylinder may be specified. Corresponding to a desired movement of a load located on the load part, the control unit receives a specification for controlling the corresponding hydraulic cylinders, for example by an operator. The control unit controls the hydraulic system of the industrial truck corresponding to the specification such that the target speed and/or the target acceleration is specified to the piston rod of the at least one hydraulic cylinder. In so doing, the piston rod of the hydraulic cylinder acts on the lift frame and/or the load part of the lift frame. Moreover, at least one sensor unit is provided according to the invention that measures an actual speed, an actual acceleration, or an actual speed and actual acceleration of the piston rod of the at least one hydraulic cylinder. The at least one sensor unit can for example comprise a speed sensor that directly measures the actual speed of the piston rod. The at least one sensor unit can also comprise an acceleration sensor that directly measures the actual acceleration of the piston rod. The at least one sensor unit can also comprise a position sensor, wherein the sensor unit or the control unit then determines the current actual speed, or respectively actual acceleration of the piston rod from the change in position of the piston rod. The at least one sensor unit can in particular have several sensors, for example a speed sensor and an acceleration sensor. The at least one sensor unit can for example be arranged on the hydraulic cylinder, in particular on the piston rod of the hydraulic cylinder. The measured actual speed and/or actual acceleration of the piston rod is transmitted to the control unit that subsequently determines the control deviation of the actual speed from the target speed, and/or the actual acceleration from the target acceleration. The control deviation can accordingly comprise a difference between the actual and the target speed, and between the actual and target acceleration. Of course, the differences can also be separate control deviations of the actual speed and acceleration. Subsequently, the control unit adjusts the actual speed according to the invention and/or the actual acceleration of the piston rod based on the determined control deviation. The control unit therefore checks whether the target values of the movement, or rate of change, variables of speed and/or acceleration of the piston rod that are needed for the movement request have actually been reached, and adjusts the actual speed and/or the actual acceleration if the respective actual values and target values of the movement variables of the piston rod of the hydraulic cylinder do not correspond. The at least one hydraulic cylinder is supplied with hydraulic fluid by the hydraulic power unit. The hydraulic power unit can comprise at least one hydraulic pump and a hydraulic tank connected to the hydraulic pump.

According to the invention, there is not merely a specification of the movement parameter, i.e., the actual speed, or respectively acceleration for the load; rather, information is processed about the actual movement of the piston rod of the at least one hydraulic cylinder, and accordingly the load with a corresponding adjustment. A desired load movement can be achieved and maintained much more precisely and reliably by the regulation of the movement of the piston rod of the hydraulic cylinder according to the invention and hence the movement of the load on the load part. In particular, external disturbance variables can be compensated such as dragging loads caused by the braking processes or accelerations of the industrial truck and oil temperature changes. Accordingly, more reliable and stable simultaneous movement of a plurality of hydraulic cylinders, in particular along different axes, such as a simultaneous lifting process and thrusting process is also possible. Furthermore, the regulation according to the invention simplifies the design of the hydraulic system. In comparison to the prior art, load sensing systems and pressure scales, for example, can be omitted.

The at least one hydraulic cylinder can for example be a lift cylinder for lifting and lowering the load part. Consequently, the lifting and lowering of the load part can be controlled by regulating according to the invention the movement of the piston rod of the lift cylinder. In so doing, the lift frame can also be lifted and lowered together with the load part, and the mast lift can be traversed. If only the load part is lifted or lowered, the free lift is traversed. The at least one hydraulic cylinder can also be a tilt cylinder for tilting the entire lift frame or the load part forward and backward. Correspondingly by regulating the movement of the piston rod of the tilt cylinder, the forward tilt and backward tilt of the entire lift frame or load part can be controlled. The at least one hydraulic cylinder can also be a thrust cylinder for moving the lift frame or load part forward and backward so that the forward and backward movement of the lift frame can be controlled by regulating the movement of the piston rod of the thrust cylinder. Either a lifting process, tilting process or thrusting process can therefore be executed by the at least one hydraulic cylinder. The industrial truck can also have a plurality of the aforementioned hydraulic cylinders. For example, the industrial truck can comprise three hydraulic cylinders, wherein a first hydraulic cylinder is a lift cylinder for lifting and lowering the load part, a second hydraulic cylinder is a tilt cylinder for tilting the lift frame, or respectively the load part forward and backward, and a third hydraulic cylinder is a thrust cylinder for moving the lift frame, or respectively the load part forward and backward. Accordingly, a load located on the load part can be moved very precisely in a plurality of movement directions. In principle, the at least one hydraulic cylinder can be a single-acting hydraulic cylinder or a double-acting hydraulic cylinder, in particular a differential cylinder.

According to another embodiment, the control unit of the industrial truck is moreover designed to determine an actual acceleration from an actual speed determined by the at least one sensor unit, and/or determine an actual speed of the piston rod from an actual acceleration determined by the at least one sensor unit. If the sensor unit comprises for example a speed sensor, the actual acceleration of the piston rod can be calculated by the control unit from the actual speed measured by the actual speed sensor, in particular by a differentiation over time. If the sensor unit comprises for example an acceleration sensor, the actual speed of the piston rod can be calculated by the control unit from the actual acceleration measured by the actual acceleration sensor, in particular by an integration over time. If the actual speed of the piston rod is calculated from a measured acceleration of the piston rod, it can moreover also be provided that the actual acceleration or delay of the entire industrial truck is determined and considered in the calculation.

According to another embodiment, the industrial truck can comprise at least one deformation sensor that is designed to measure a deformation of the lift frame, wherein the control unit is moreover designed to regulate the movement speed and/or the actual acceleration of the piston rod of the at least one hydraulic cylinder on the basis of the measured deformation of the lift frame. Correspondingly, the method can furthermore comprise the step of measuring the deformation of the lift frame by at least one deformation sensor and regulating the movement of the piston rod on the basis of the measured deformation of the lift frame. Such a deformation sensor can for example be a strain sensor. A bending of the lift frame, in particular the lift mast, can be determined by the deformation sensor. This information on the bending of the lift mast can also be supplied to the control unit that controls the at least one hydraulic cylinder. Accordingly, oscillations or vibrations of the mast can be compensated.

According to another embodiment, the control unit can be designed to control the movement speed and/or the actual acceleration of the piston rod of the at least one hydraulic cylinder by changing the volumetric flow of the hydraulic fluid generated by the hydraulic power unit. According to another preferred embodiment, it can be provided for the hydraulic system to comprise at least one control valve that serves to control the supply of the at least one hydraulic cylinder with hydraulic fluid from the hydraulic power unit. Correspondingly, the movement speed and/or the actual acceleration of the piston rod of the at least one hydraulic cylinder can result from changing the volumetric flow of hydraulic fluid generated by the hydraulic power unit, in particular by a hydraulic pump of the hydraulic power unit, or by changing the valve position of a control valve upstream from the at least one hydraulic cylinder. Likewise, the movement speed, or respectively the actual acceleration of the piston rod can be regulated both by a change in the volumetric flow by the hydraulic power unit, as well as by a change in the valve position. Accordingly for example the control unit of the piston rod of the hydraulic cylinder can specify a target speed by a defined volumetric flow of hydraulic fluid, and/or a defined valve position of the control valve. In addition, the actual speed can be adjusted to adapt to the target specification. An acceleration of the piston rod can for example be achieved by changing the volumetric flow of hydraulic fluid. The at least one control valve can for example be a proportional valve or a discrete switch valve. The proportional valve differs from the discrete switch valve in that it can also assume intermediate states between the valve positions. The control valve can for example be a 2/2-way proportional valve, or a 2/2-way switch valve, or a 3/3-way proportional valve, or a 3/3-way switch valve, or a 4/3-way proportional valve, or a 4/3-way switch valve. In particular, a plurality of control valves can be provided that regulate the inflow and return flow of hydraulic fluid to a plurality of hydraulic cylinders. Likewise, separate control valves can be provided for the inflow and return flow.

The industrial truck according to the illustrated embodiment of the disclosure, is suitable for carrying out the method of the disclosure. The method can be carried out by the industrial truck according to the invention.

### BRIEF DESCRIPTION OF THE DRAWINGS

The invention will be explained below with reference to the figures.

FIG. 1 shows a schematic view of an industrial truck according to one embodiment of the disclosure.

FIG. 2 shows the hydraulic system of the industrial truck according to the illustrated embodiment.

FIG. 3 shows a flow chart of the control loop according to the illustrated embodiment.

### DETAILED DESCRIPTION OF THE INVENTION

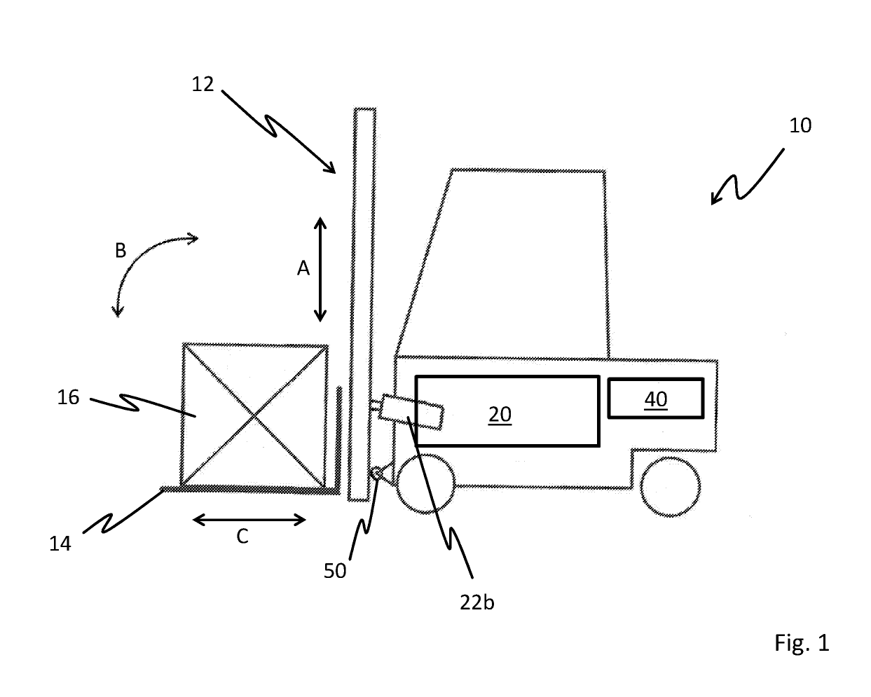

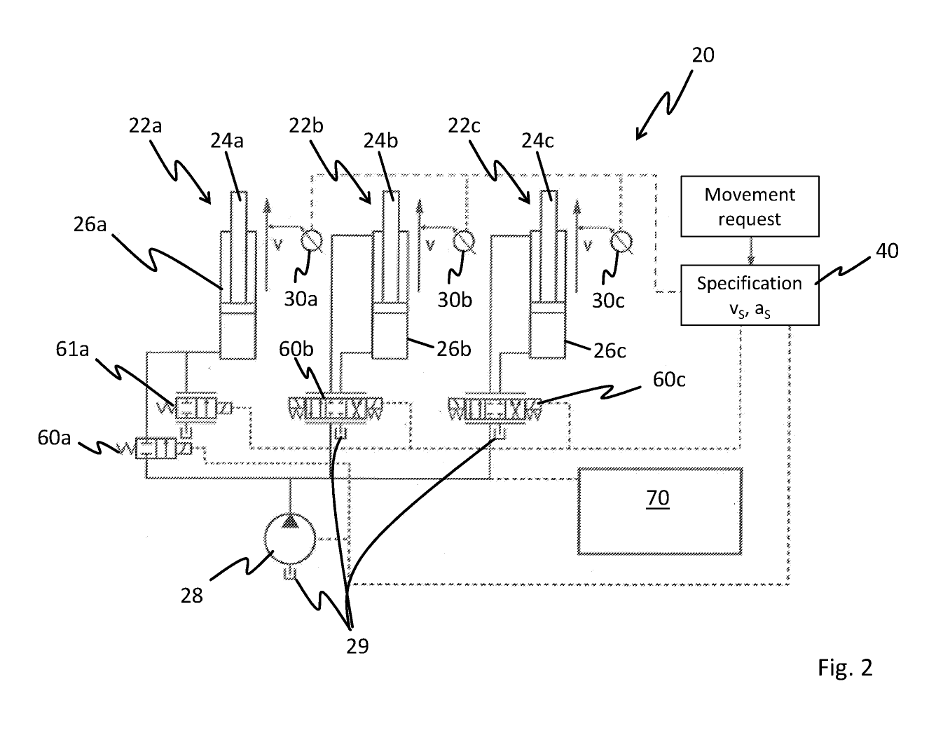

FIG. 1 shows an embodiment of the industrial truck 10 according to the present disclosure. A lift frame 12 with a load part 14 can be seen as well as a hydraulic system 20 and a control unit 40. The hydraulic system 20 shown in FIG. 1 comprises a tilt cylinder 22b as a hydraulic cylinder. To measure the actual speed or the actual acceleration of the piston rod of the tilt cylinder 22b, the tilt cylinder 22b employees a sensor shown in FIG. 2. The entire lift frame 12 can be tilted by the tilt cylinder 22b in the direction identified by arrow B. Moreover, the industrial truck can have one or more lift cylinders for extending the lift frame 12, or respectively the load part 14 along the movement direction identified with A. The industrial truck can also have one or more thrust cylinders for moving the lift frame 12, or respectively the load part 14 along the movement direction identified with C. In addition, a deformation sensor can be seen in FIG. 1 with reference sign 50 for identifying a bending of the mast.

FIG. 2 shows a possible embodiment of the hydraulic system 20 and its interaction with the control unit 40. The hydraulic system 20 comprises three hydraulic cylinders 22a, 22b, 22c, four control valves 60a, 60b, 60c, 61a as well as a hydraulic power unit consisting of a hydraulic tank 29 and a hydraulic pump 28. The hydraulic cylinders 22a, 22b, 22c each have a piston rod 24a, 24b, 24c and a cylinder housing 26a, 26b, 26c and a sensor 30a, 30b, 30c arranged on the respective cylinder housing for measuring the actual speed, or respectively the actual acceleration of the piston rods 24a, 24b, 24c. Moreover, additional consumers 70 can be connected to the hydraulic system 20. In the exemplary embodiment shown in FIG. 2, the hydraulic cylinder 22a is a lift cylinder, the hydraulic cylinder 22b is a tilt cylinder, and the hydraulic cylinder 22c is a thrust cylinder. The lift cylinder 22a is a single-acting cylinder with at least one line connection and a separate supply valve 60a and return valve 61a. Both valves 60a, 61a are 2/2-way valves with two possible valves positions, a flow position and off position. The tilt cylinder 22b and the thrust cylinder 22c are dual-acting cylinders and accordingly have two line connections. The inflow and return of hydraulic fluid to the tilt cylinder 22b, or respectively the thrust cylinder 22c is regulated by the valves 60b, 60c. The valves 60a, 60b, 60c, 61a can be electrically actuated by the control unit 40. The dashed lines represent electrical connecting lines. The solid lines represent hydraulic lines. The valves 60b, 60c are 3/3-way valves with three possible valve positions: A first flow position for moving the respective piston rod out of the respective cylinder housing, an off position, and a second flow position for moving the respective piston rod into the respective cylinder housing.

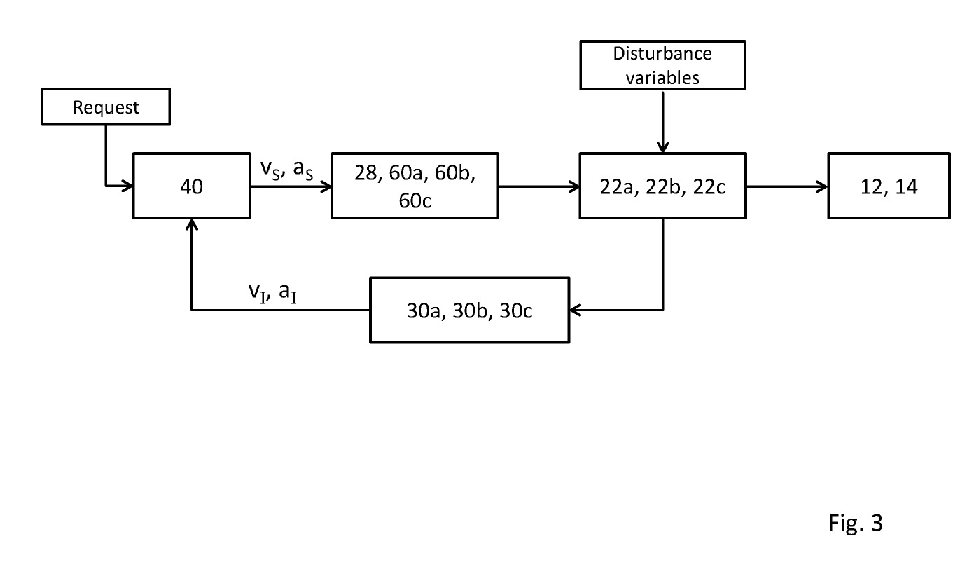

The functioning of the invention is explained below with reference to FIGS. 2 and 3. Corresponding to a request to move the load 16 transported by the industrial truck, the control unit 40 receives a request to move a load located on the load part 14, for example from an operator. Corresponding to this specification, the control apparatus 40 specifies a target speed vₛ or respectively, a target acceleration aₛ for the hydraulic pump 28 and the supply valves 60a, 60b, 60c. This can for example occur by specifying corresponding control flows. The hydraulic pump 28 generates a necessary volumetric flow for the desired movement speed of the piston rods 24a, 24b, 24c of the hydraulic cylinders 22a, 22b, 22c. The valves 60a, 60b, 60c distribute this volumetric flow to the hydraulic cylinders 22a, 22b, 22c corresponding to the movement request. Since all of the valves 60a, 60b, 60c, 61a are proportional valves, the inflow and return flow of hydraulic fluid to the cylinders can be precisely controlled. In the event for example of a lift request, the valves 60b and 60c are switched to the off position, whereas the valve 60a switches to the flow position. Accordingly, only the lift cylinder 22a is supplied with hydraulic fluid. The return valve 61a is also in off position. The load is therefore lifted by an extension of the lift frame. If, in addition to the lifting process, the load is also to be moved forward, the valve 60c also switches to the first flow position to push the piston rod 24c of the thrust cylinder 22c out of the housing 26c.

The hydraulic pump 28 and the valves 60a, 60b, 60c are controlled electrically as mentioned. The control unit 40 can accordingly transmit the corresponding target speed, or respectively target acceleration, as electric current to the hydraulic pump 28, or respectively as electric currents to the respective valves 60a, 60b, 60c. The volumetric flow to the hydraulic cylinders 22a, 22b, 22c that arises produces a corresponding speed, or respectively acceleration of the piston rod of the respective hydraulic cylinders, whereby the lift frame 12, or respectively the load part 14 is moved. During the movement of the piston rods 24a, 24b, 24c and the corresponding hydraulic cylinders 22a, 22b, 22b, the sensors 30a, 30b, 30c measure the actual speed, or respectively the actual acceleration of the piston rods 24a, 24b, 24c relative to the cylinder housing 26a, 26b, 26c. The determined actual speeds, or respectively actual accelerations are returned to the control unit 40 that then adapts the manipulated variables of the specified speed vₛ, or respectively specified acceleration aₛ. By this continuous control loop, a requested speed or acceleration of the load can be achieved and maintained much more precisely. In particular, external manipulated variables that cause a deviation of the actual speed, or respectively actual acceleration from the target speed, or respectively the target acceleration, can be compensated by this control loop.

The return valve 61a is also electrically controlled to enable regulation according to the invention also while lowering the lift frame 12, or respectively load part 14 controlled by the lift cylinder 22a. In contrast to the valves 60b, 60c, the pump 28 does not have to work in order to return the piston rod 24a since the cylinder 22a is a single-acting cylinder. This obviates complicated and expensive hydraulic regulation and makes it possible to regulate the lowering speed, if applicable also depending on the load, lift height or other parameters.

Moreover, an optimized movement can occur in the end regions of the hydraulic cylinder, i.e., close to the maximum or minimum extension position of the piston rod. For example, a limitation of the actual speed and/or acceleration values in the end regions can be provided to gently reach the stop position. Likewise, the actual speed, or respectively acceleration of the piston rod can be regulated depending on the position of the axis, lift height, bending of the mast, and/or the weight of the load moved by the piston rod.

1. An industrial truck, comprising:
a lift frame having a load part for carrying a load;
a hydraulic system including at least one hydraulic cylinder having a piston rod disposed within a cylindrical housing, and a hydraulic power unit, the piston rod of the hydraulic cylinder connecting to the lift frame;
at least one sensor configured to determine at least one of: (i) an actual speed of the piston rod of the at least one hydraulic cylinder, and (ii) an actual acceleration of the piston rod of the at least one hydraulic cylinder; and
a control unit configured to: (i) receive at least one of a target speed of the piston rod and a target acceleration of the piston rod, (ii) determine at least one of a speed control deviation value by comparing the actual speed to the target speed, and an acceleration control deviation value by comparing the actual acceleration to the target acceleration, and, (iii) regulate at least one of the actual speed of the piston rod based on the speed control deviation value and the actual acceleration of the piston rod based on the acceleration control deviation value.

2. The industrial truck of claim 1, wherein the at least one hydraulic cylinder is at least one of: (i) at least one lift cylinder configured to lift and lower the load part, (ii) at least one tilt cylinder configured to tilt the lift frame forward and aft, and (iii) at least one thrust cylinder configured to move the lift frame forward and aft.

3. The industrial truck of claim 1, wherein the at least one hydraulic cylinder is at least one of: (i) a single-acting hydraulic cylinder, (ii) a double-acting hydraulic cylinder, and (iii) a differential hydraulic cylinder.

4. The industrial truck of claim 1, wherein the control unit is configured to determine at least one of: (i) the actual acceleration of the piston rod from the actual speed of the piston rod when the actual speed is sensed, and (ii) the actual speed of the piston rod from the actual acceleration when the actual acceleration is sensed.

5. The industrial truck of claim 1, further comprising at least one deformation sensor configured to measure a deformation of the lift frame, and wherein the control unit is configured to regulate at least one of: (i) the actual speed of the piston rod based on the measured deformation of the lift frame, and (ii) the actual acceleration of the piston rod based on the measured deformation of the lift frame.

6. The industrial truck of claim 1, wherein the hydraulic power unit includes a hydraulic pump for changing a volumetric flow of hydraulic fluid from the hydraulic power unit and wherein the control unit is configured to control at least one of: (i) the actual speed of the piston rod by changing the volumetric flow of the hydraulic fluid from the hydraulic power unit, and (ii), the actual acceleration of the piston rod by changing the volumetric flow of the hydraulic fluid from the hydraulic power unit.

7. The industrial truck of claim 1, wherein the hydraulic system includes at least one control valve, for controlling a supply of hydraulic fluid in the at least one hydraulic cylinder from the hydraulic power unit.

8. The industrial truck of claim 7 wherein the at least one control valve includes at least one of a proportional valve and a discrete switch valve.

9. The industrial truck of claim 7, wherein the control unit is configured to regulate at least one of: (i) the actual speed of the piston rod of the at least one hydraulic cylinder by changing a valve position of the at least one control valve, and (ii) the actual acceleration of the piston rod of the at least one hydraulic cylinder by changing a valve position of the at least one control valve.

10. A method for regulating the movement of a piston rod of at least one hydraulic cylinder of the industrial truck, the piston rod acting on a lift frame of the industrial truck, wherein the method comprises the steps of:
storing at least one of: (i) a target speed signal of the piston rod in a control unit of the industrial truck, and (ii) a target acceleration signal of the piston rod in the control unit of the industrial truck;
determining at least one of: (i) an actual speed of the piston rod by a sensing unit and issuing an actual speed signal indicative thereof, and (ii) an actual acceleration of the piston rod by the sensing unit and issuing an actual acceleration signal indicative thereof;
comparing the actual speed signal to the target speed signal by the control unit and issuing a speed deviation control signal indicative of a difference therebetween, when the actual speed is sensed;
comparing the actual acceleration signal to the target acceleration signal by the control unit and issuing an acceleration deviation control signal indicative of a difference therebetween, when the actual acceleration is sensed; and,
regulating the movement of the piston rod by modifying at least one of: (i) the actual speed of the piston rod by the control unit based on the speed deviation control signal, and (ii) the actual acceleration of the piston rod by the control unit based on the acceleration deviation control signal.

11. The method of claim 10, wherein the step of regulating the movement of the piston rod further comprises the step of lifting and lowering the lift frame by a lift cylinder.

12. The method of claim 10, wherein the step of regulating the movement of the piston rod further comprises the step of tilting the lift frame forward and aft by a tilt cylinder.

13. The method of claim 10, wherein the step of regulating the movement of the piston rod further comprises the step of displacing the lift frame forward and aft by a thrust cylinder.

14. The method of claim 10, wherein the step of determining at least one of the actual speed and the actual acceleration of the piston rod, further comprises the step of determining the actual speed of the piston rod from sensing the actual acceleration of the piston rod.

15. The method of claim 10, wherein the step of determining at least one of the actual speed and the actual acceleration of the piston rod, further comprises the step of determining the actual acceleration of the piston rod from sensing the actual speed of the piston rod.

16. The method of claim 10, wherein the step of regulating the movement of the piston rod further comprises the step of measuring a displacement of the lift frame by a deformation measurement sensor disposed in combination with the lift frame.

17. The method of claim 16, wherein the step of measuring the displacement of the lift frame includes the step of measuring the displacement of the lift frame by a deformation measurement sensor on the lift frame.

18. The method of claim 10, wherein the step of regulating the movement of a piston rod in a hydraulic cylinder comprises the step of varying a volumetric flow of hydraulic fluid from a hydraulic power unit.

19. The method of claim 10, wherein the step of regulating the movement of a piston rod in a hydraulic cylinder comprises the step of changing a position of a control valve upstream of the at least one hydraulic cylinder.

20. An industrial truck, comprising:
a lift frame having a load part for receiving a load;
a hydraulic system including at least one hydraulic cylinder having a piston rod disposed within a cylindrical housing, and a hydraulic power unit, the piston rod of the at least one hydraulic cylinder disposed in combination with the lift frame;
at least one sensor configured to determine at least one of an actual speed and an actual acceleration of the piston rod of the at least one hydraulic cylinder; the sensor issuing an actual speed signal indicative of the actual speed of the piston rod if the actual speed is sensed and an actual acceleration signal indicative of the actual acceleration of the piston rod if the actual acceleration is sensed; and,
a control unit configured to: (i) receive at least one of a target speed signal and a target acceleration signal associated with the piston rod of the at least one hydraulic cylinder, (ii) compare the actual speed signal to the target speed signal and issue a speed deviation control signal indicative of a difference therebetween, when the actual speed is sensed, (iii) compare the actual acceleration signal to the target acceleration signal and issue an acceleration deviation control signal indicative of the difference there between, when the actual acceleration is sensed and (iv) regulating at least one of the actual speed of the piston rod based on the speed deviation control signal, and the actual acceleration of the piston rod based on the acceleration deviation control signal.
